(19) United States
(12) Patent Application Publication
(10) Pub. No.: US 2012/0065988 A1
(43) Pub. Date: Mar. 15, 2012

(54) METHODS FOR MAKING COMPLEX THERAPEUTIC CLINICAL DECISIONS

(76) Inventor: THOMAS LOSER, LEIPZIG (DE)

(21) Appl. No.: 13/269,998

(22) Filed: Oct. 10, 2011

Related U.S. Application Data
(63) Continuation of application No. 12/402,354, filed on Mar. 11, 2009.

(51) Int. Cl. G06Q 50/22

(52) U.S. Cl. 705/2

(57) ABSTRACT

Embodiments of the present invention relate to methods of making therapeutic decisions in the course of medical treatment. Some embodiments include using mathematical methods such as analytic geometric methods to determine the relationship of a patient's initial and/or current health state to a desired health state and/or an undesired health state. Furthermore, some embodiments include defining a health feature space including a plurality of health parameters and time, and representing the time evolution of the patient health state as a space curve trajectory in a multidimensional space. Still further some embodiments include calculating a target trajectory and/or a complication trajectory and determining which health parameters to adjust in order to produce a desired time evolution result.

This is a continuation application of U.S. patent application Ser. No. 12/402,354, which was filed on Mar. 11, 2009, which claimed priority to EP 06018878, which was filed on Sep. 8, 2006. Some embodiments generally relate to a method for analyzing and/or monitoring physiological and/or pathological parameters of a patient. Embodiments can be particularly suited for early detection of pathological conditions and for creating protocols for preventing pathological conditions. Some embodiments include diagnosing pathological conditions using multiple parameters.

### FIELD OF THE INVENTION

### Background

Early diagnosis of various pathological conditions and initiation of therapies based on empirical evidence in the early phase of the disorder is a developing field. Medical diagnoses and therapy decisions are in many cases made with the help of physiological and/or pathological parameter measurements. Such measurements include detecting the presence and/or quantity of indicator compounds in body fluid samples. Such measurements can enable early intervention in some pathological conditions. In general, such measurements are analyzed and classified, for instance, as either positive or negative results.

The use of threshold values can enable one to classify an observation as positive or negative. This procedure for the diagnosis of diseases is a one-parameter classification method that is restricted to the assignment of the measured value to one of the two classes. However, this process neglects how far the observation is from the threshold. The result is that a measured value just under the threshold is treated the same as an observation that is very far below the threshold. Indeed, traditional procedures for the diagnosis of a disorder with the help of indicators conveys a clue, but has serious disadvantages. Particularly, it requires the user to have a profound understanding of the evolving health state of a complex organism. Moreover, critical decisions often must be made despite significant uncertainty and conflicting indicators.

Some embodiments of the present invention provide diagnostic methods that differ from the prior art, and may enable therapeutic decisions to be made with greater certainty and/or at earlier stages of a disorder.

### SUMMARY OF THE INVENTION

In accordance with some embodiments, there is provided a method that allows early detection of diseases on the basis of physiological and pathological parameters of the patient and wherein at any time, e.g. pathogenesis or convalescence, an instruction value can be calculated that is suitable to treat the condition of the patient and cause its evolution from an unhealthy to a healthy state.

In accordance with some embodiments of the invention there is provided a method for analyzing and/or monitoring physiological and/or pathological parameters of a patient, comprising choosing physiological and/or pathological parameters typical for a disorder, wherein the number of chosen parameters is at least three; forming a multidimensional feature space, wherein each of the chosen parameters forms a dimension of the feature space and the time forms a further dimension of the feature space; determining of at least a first space range and at least a second space range within the feature space, wherein in the first space range each of the chosen parameters and/or the time have values that have been given as target values; in the second space range at least one of the parameters and/or the time have values that have been given as unwanted values; collecting measured values of the patient for the chosen parameters typical for a first condition (initial state) of the patient and assigning of the measured values to the feature space, in order to form a first measured point in the feature space: determining of the shortest space curve (target trajectory) between the first measured point and a first space range; repeated collecting of measured values for the chosen parameters and time-dependent assigning of this measured values to the feature space, in order to form further measured points in the feature space; and determining an instruction value, if one of the further measured points is outside of the target trajectory.

According to some embodiments, the number of chosen parameters can be at least five, and advantageously can be at least ten.

### BRIEF DESCRIPTION OF THE DRAWINGS

Embodiments may take various forms, embodiments of which will be described in detail in this specification and illustrated in the accompanying drawings which form a part hereof and wherein:

FIG. 1 is a schematic drawing illustrating an evolving health state of a patient.

### DETAILED DESCRIPTION OF THE INVENTION

According to some embodiments a patient's health state can be described by a plurality of quantifiable variables, each representing a dimension in a multidimensional feature space referred to herein as a health space. As used herein, the terms health space, feature space and health feature space are interchangeable. Some embodiments include time as an additional dimension. Thus, the evolution of a patient's health state over time can be described mathematically, and a an instantaneous health state can be described as a point in health space. According to some embodiments the health space can include regions defining one or more undesirable states, desirable states, transitional states, health-neutral states and/or any combination thereof.

As used herein the term space range includes a set of points having a common characteristic. For example, the contiguous set of points in health space defining a desirable region of health states comprises a space range.

As used herein the term patient trajectory includes a first point in health space as well as further measured points defining a space curve without regard to whether the space curve includes desirable or undesirable conditions. Also as used herein the term complication trajectory includes a shortest space curve between a first condition and a space range defining an undesirable condition. Also as used herein the term target trajectory includes a shortest space curve between a first condition and a space range defining a desirable condition. According to some embodiments a patient trajectory can approach a complication trajectory or a target trajectory. Furthermore, if the patient trajectory is found to approach a complication trajectory then instruction values can be determined for bringing the patient trajectory toward the target trajectory.

According to some embodiments, analysis of the patient trajectory can provide a means for early recognition evolution of a patient's condition toward a desirable or undesirable state. Furthermore, one can determine which parameter(s) to modify, and by how much, in order to cause the patient's health state to evolve toward a target state by the most efficient route. An instruction value comprises the change in these parameters.

The instruction value can include at least one parameter to be changed so as to cause the patient trajectory to evolve along a target trajectory toward a desirable space range. According to the instruction value(s) a therapist can determine the actions necessary to effect a desired parameter change, for example by administration of a pharmaceutical agent. For instance, if the instruction value indicates that heart rate must decrease by n and blood pressure must decrease by m then a skilled practitioner can determine the appropriate drug and dosage thereof to effect the instruction value. In some embodiments, a health space can be defined for the early detection of disorders such as tumors, and can determine and/or avoid the set of physiological conditions where an effective tumor defense is no longer possible.

The following Table 1 shows exemplary set of parameters defining an initial state, a single first space range (desirable state) and two second space ranges (undesirable states).

TABLE 1

| | Initial | First Space | Second Space | Second Space |
|---|---|---|---|---|
| Parameter | State | Range | Range 1 | Range 2 |
| 1 | + | + | − | −− |
| 2 | − | + | + | −− |
| 3 | − | + | −−− | − |
| 4 | − | + | −− | − |
| 5 | −− | + | − | −− |
| 6 | − | + | −−− | − |
| 7 | −−− | + | − | −− |
| 8 | − | + | + | − |
| 9 | − | + | + | − |
| 10 | −− | + | − | −− |
| 11 | −−− | + | −−− | −−− |
| 12 | − | + | −−− | + |

The table shows 12 parameters therefore the health space has 13 dimensions (12 parameters and time). For the initial state the measured values for the parameters are generically represented as “poor” (−), “very poor” (−−) and “particularly poor” (−−−). The desired state, i.e. the first space range, is defined by all parameters having a “good” (+) value. The undesirable second space ranges 1 and 2 some parameters have values that are “poor”, “very poor” or “particularly poor”. The evolving health state of the patient, which is represented by the patient trajectory can be prevented from reaching either of the second space ranges.

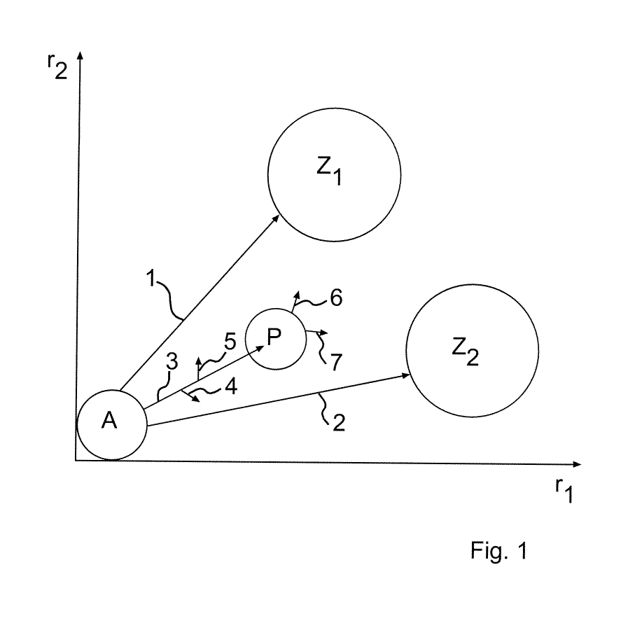

Referring to FIG. 1, a simplified two dimensional health space is shown to illustrate the principles an embodiment, and comprises generic variables r₁, and r₂. For the purpose of illustration one can assume that r₁ is time and r₂ is any health state parameter. An initial state A is shown representing the health state or condition of a patient when he enters the process of the present embodiment. The desired evolution of the patient's health state, i.e. the target trajectory, is represented by line 1, which leads to desirable health space range Z₁. An undesirable evolution of the patient's health state is represented by line 2, which leads to undesirable health space range Z₂. The actual evolution of the patient's health state, i.e. the patient trajectory, is represented by line 3. When the patient trajectory 3 deviates by a statistically significant amount from the target trajectory 1 one or more instruction values can be calculated which cause the patient trajectory 3 to approximate the target trajectory 1 and/or approach the desired health space range Z₁. Furthermore, lines 4, 5, 6 and 7 represent possible perturbations of the patient trajectory that may cause it to turn toward or away from the desired health space Z₁. A trajectory can include a tolerance range. The width of the tolerance can depend on individual risk factors such as genotype or activated oncogenes.

A wide variety of physiological and/or pathological parameters can be chosen to define a health space which may be a function of the patient's specific pathology. Some parameters may be related to, for instance, tissue condition and/or composition, or the patient's age. Some parameters can be related to, and/or quantify, one or more of inflammation, acute inflammation, nutritional state, infection, sepsis, physiological aging, hydration, electrolyte levels, mineral levels, metabolic state, hormonal levels, connective tissue metabolism, haemostasis, blood flow, immune system processes, immunosurveillance, diabetes, and/or therapeutic processes such as doses of irradiation and medicaments. According to some embodiments it may be advantageous to select one or more parameters that are typical of the patient's genotype. In some embodiments, a genotype may indicate one or more additional undesirable space ranges and/or complication trajectories. The selected parameters may be collective, continuous, and/or discontinuous. According to some embodiments, instruction value(s) can be transferred to a patient warning system, which triggers a visual or audible alert, for example.

According to one example a set of parameters for defining a health space for assessing the risk an adrenal tumor include: curatively treated mammary carcinoma, genotype A, osteoporosis, chronic smoker, dehydration, acute inflammation, poor mineral and trace element status. Advantageously, at least two of the physiological and/or pathological parameters chosen are chemical indicators typical of a disorder.

The term “indicator” as used herein includes compounds or elements which—according to their nature—are produced in biological systems or are introduced in biological systems and the presence or concentration (e.g. in a particular organ) thereof is a characteristic for a biological process or a biological condition. For instance, chemical indicators can include compounds that are produced by tumor cells, are induced by a tumor in other body cells, and/or are trans-formed by tumor cells. Such indicators can include, without limitation, macromolecules (e.g. proteins, nucleic acids, carbohydrates, glycoprotiens and the like), or trace elements. In some embodiments, chemical indicators can include compounds and/or elements typical of osteoclasis processes such as osteoporosis.

In general, an organism undergoes a number of state changes as a function of time starting from its genesis until death. The state changes can be monitored with the help of any number of measured quantities such as size, weight, temperature, medical imaging techniques, and the like. The measured quantities define a feature space or phase space, respectively, wherein the organism's state continues to evolve as a function of time. Thus, the organism's state defines a time dependant space curve, i.e. a trajectory. An ideal trajectory is an unperturbed trajectory that is only determined by healthy and/or non-pathological physiological changes of the organism that occur until natural death, e.g. building bone mass, loss of bone mass, hormonal changes from puberty to menopause, age-dependant drop in basal metabolic rate, cardiac index, vital capacity, muscle strength, and countless others.

According to some embodiments a health space may be valid for each member of a species. However, due to the differences in genotype within a species, the initial conditions and/or life trajectory for each member of the species can vary widely. The initial conditions of an individual trajectory may affect it's behavior after a perturbation. Accordingly, similar trajectories having different initial conditions may respond differently to the same perturbation. For instance, one trajectory may be stabilized by the perturbation while the other may oscillate or become increasingly erratic.

According to some embodiments, e.g. regarding acute medical conditions, parts of the general patient trajectory may be particularly important, e.g. the condition of an organ or of the organism before and after defined disorders or interventions. Therefore, a subset of parameters can be selected to define a health space that neglects some less important or insignificant parameters. In some embodiments the initial state is marked by an event such as the completion of an operation, the beginning of respiration, the diagnosis of sepsis or any of a wide variety of medically important events. From the initial state there can develop different final states. For instance, after a successful curative mammary carcinoma operation no metastases form within 20 years. An alternative final state can include the formation of a metastasis or a postoperative complication, e.g. pneumonia or sepsis. A trajectory toward a desirable health state is a target trajectory, and all the other trajectories can be referred to as complication trajectories.

By recording observed target and complication trajectories one can predict and control patient trajectories of other patients. In order to effect control over a patient trajectory according to some embodiments one must define and frequently observe a patient's health space parameters, and act on instruction values when necessary. If the patient trajectory lies within an error band of a target trajectory no additional action is required; however, when it is outside and/or near a complication trajectory then the shortest way toward the target trajectory is determined and provided as instruction value. In some embodiments several observed parameters may differ and/or be in conflict with each other. Therefore, a weighting of the parameters can be carried out to determine and/or define their relative importance. In some embodiments the weighting factors themselves can be time dependant.

According to one embodiment a health space and space ranges can be defined as follows. Determine the physiological and/or pathological parameters typical of a disorder, for example formation of a tumor in a given tumor tissue. Define the health space, wherein each parameter forms one dimension of the feature space and time is a further dimension of the feature space. Provide known values of the physiological and/or pathological parameters from patient data banks obtained, for instance, from clinical studies. The known values are determined to be healthy states, diseased states, or the like. Accordingly, healthy and unhealthy space ranges are known.

According to some embodiments a patient trajectory can be precluded from evolving toward a pathological space range, and instead caused to evolve toward a healthy target space range. For instance, a patient's complete set of health parameters can be identified and recorded at time t₀. The patient's parameters are again observed and recorded at times t₁-tₙ. The repeated determination of the current health state of the patient enables determination the patient trajectory and its position and direction relative to the target trajectory. Instruction values can be calculated at any time after tₒ. Thus, embodiments permit the early detection of pathology and indicates which health state parameters of the patient could be altered to achieve evolution of a patient trajectory toward a desired state.

### EXAMPLES

### Example 1

In Example 1 initial state A is characterized by a successful curative mammary carcinoma operation with subsequent irradiation and chemotherapy. The health space is defined parameters including time and the levels of the following chemical indicators: GOT, GPT, yGT, alkaline phosphatase (AP), LDH, C-reactive protein (CRP), CEA, CA 15-3, Glue, PTT, haematocrit, zinc, and selenium. A healthy first space range Z₁, and unhealthy second space range Z₂ are defined according to known standards. Z₁ includes a freedom from metastasis over 20 years. Z₂ includes evidence of metastases within 20 years. The following Table 2 shows values for the initial state A and the undesired state Z₂.

TABLE 2

| | | |
|---|---|---|
| Parameter | Initial State A | State Z₂ |

| | | | | |
|---|---|---|---|---|
| GOT | 12 | U/l | 24 | U/l |
| GPT | 15 | U/l | 12 | U/l |
| yGT | 4 | U/l | 4 | U/l |
| AP | 62 | U/l | 62 | U/l |
| LDH | 151 | U/l | 295 | U/l |
| CRP | 5 | mg/l | 67 | mg/l |
| CEA | 2 | mg/l | 43 | mg/l |
| CA 15-3 | 2 | kU/l | 55 | kU/l |
| Gluc | 5.2 | mmol/l | 17.4 | mmol/l |
| haematocrit | 46 | l/l | 59 | l/l |
| PIT | 35 | s | 22 | s |
| Zn | 1.3 | mg/l | 0.26 | mg/l |
| Se | 90 | mg/l | 23 | mg/l |

### Example 2

According to a second example an initial state A is characterized by the completion of a bypass operation and transfer to an intensive care unit with respiration. The health space is defined by parameters including time and pO₂, pCO₂, pH. AF, PEEP, CRP, PCT, Glue, selenium, PTT, and T. A healthy first space range Z₁ is defined by known standards for the identified parameters. i.e. conditions that are known to be health) and desirable. A undesired second space range Z₂ includes the development of a respiration-associated pneumonia. The following Table 3 shows values for the initial state A and the undesired state Z₂.

TABLE 3

| | | |
|---|---|---|
| Parameter | Initial State A | State Z₂ |

| pO₂ | 90 | mmHg | 48 | mmHg |
|---|---|---|---|---|
| pCO₂ | 40 | mmHg | 51 | mmHg |
| pH | 7.4 | | 7.7 | |
| AF | 15/min | | 29/min | |
| PEEP | 5 | mbar | 22 | mbar |
| CRP | 5 | mg/l | 204 | mg/l |
| PCT | 0.3 | | 10 | |
| Gluc | 4.8 | mmol/l | 22.5 | mmol/l |
| Se | 104 | mg/l | 18 | mg/l |
| PIT | 40 | s | 18 | s |

| | | |
|---|---|---|
| T | 36.8 | 39.4 |

### Example 3

According to a third example an initial state A is characterized by the beginning of menopause. The health space is defined by time and levels of the following chemical indicators: Ca⁺², PO₃⁻³, AP, acid phosphatase (SP), DH, PTH, calcitonin (CT), growth hormone STH, osteocalcin, vitamin D. A desirable first space range Z₁ includes a loss of bone mass <0.5-0.7%/a (trabecular) and ≦0.5-0.6%/a (cortical). An undesired space range Z₂ includes a loss of bone mass >0.7 and 0.6%/a, respectively within the next 5 years. The following Table 4 shows values for initial state A and the undesired state Z₂.

TABLE 4

| | | |
|---|---|---|
| Parameter | Initial State A | State Z₂ |

| Ca⁺⁺ | 2.5 | mmol/l | 2.4 | mmol/l |
|---|---|---|---|---|
| PO₃⁻⁻⁻ | 1.2 | mmol/l | 1.3 | mmol/l |
| AP | 110 | U/l | 200 | U/l |
| SP | 10 | U/l | 20 | U/l |
| CT (calcitonin) | 8 | ng/l | 1 | ng/l |
| STH (growth | 4 | mg/l | not detectable | |
| hormone) | | | | |
| osteocalcin | 10 | ng/l | 4 | ng/l |
| vitamin D | 125 | pmol/l | 12 | pmol/l |

Having this described the invention, it is now claimed:

1. A method for making therapeutic decisions for remediating the health condition of a human patient, comprising:
identifying a plurality of health parameters including physiological and/or pathological parameters typical for a disorder, wherein the number of health parameters is at least three;
forming a multidimensional health space, wherein each of the identified parameters defines a dimension of the health space and time defines a further dimension of the health space;
determining at least a first space range and second space range within the health space, wherein the first space range defines a healthy condition and each of the identified health parameters comprise target values, and wherein the second space range defines an unhealthy condition at least one of the identified health parameters has an undesirable value;
collecting measured values of the identified health parameters of the patient defining an initial health state of the patient and defining a point in the health space;
determining a target trajectory comprising the shortest space curve between the initial health state and the first space range;
recursively collecting measured values of the identified health parameters and calculating the patient's health state as a function of time defining patient trajectory comprising a space curve; and
determining an instruction value comprising a perturbation of one or more identified health parameters calculated to cause the patient trajectory to evolve toward the first space range.

2. The method according to claim 1, wherein the identified health parameters comprise at least two parameters that are chemical indicators for the presence of a disorder.

3. The method according to claim 1, wherein the identified health parameters comprise parameters that indicate or suggest the health state of one or more of a tissue, an organ or the patient, and wherein the parameters comprise at least the age of the patient and a tissue composition parameter.

4. The method according to claim 3, wherein the tissue composition parameter comprises the a cell type the tissue and/or a chemical composition of the tissue.

5. The method according to claim 1, wherein the identified health parameters comprise parameters selected from one or more of levels of chemical indicators typical of inflammations of the patient, levels of chemical indicators typical of the nutritional state of the patient, quantities typical of infections of the patient, and levels of chemical indicators typical of a physiological aging process.

6. The method according to claim 5, wherein the parameters typical of the nutritional state of the patient comprise one or more of degree of hydration, electrolyte levels of the patient or trace element levels.

7. The method according to claim 5, wherein the parameters typical of a physiological aging process comprise one or more of a hormone concentration, levels of chemical indicators for connective tissue metabolism or levels of chemical indicators for diabetes.

8. The method according to claim 1, wherein the determination of an instruction value comprises determining of the shortest space curve between the temporally last measured point and the first space range.

9. The method according to claim 8, wherein the instruction value includes at least one identified health parameters to be changed.

10. The method according to claim 1, wherein the determination of an instruction value comprises the calculating the shortest space curve between the temporally last measured point and the target trajectory.

11. The method according to claim 10, wherein the instruction value includes at least one identified health parameter to be changed.

12. The method according to claim 1, wherein the method further comprises determining a complication trajectory comprising the shortest space curve between the initial health state and the at least one second space range.

13. The method according to claim 1, wherein the point defining the initial health state and the further measured points define a patient trajectory.

14. The method according to claim 1, wherein the target trajectory, the patient trajectory and a complication trajectory are compared with each other to determine an instruction value.

15. The method according to claim 1, wherein the target trajectory is compared to the patient trajectory to determine an instruction value.
